(19) United States
(12) Patent Application Publication
(10) Pub. No.: US 2014/0139916 A1
(43) Pub. Date: May 22, 2014

(54) ELECTRONIC IMAGE DISPLAY APPARATUS

(71) Applicant: MITAKA KOHKI CO., LTD., Tokyo (JP)

(72) Inventors: Masao DOI, Tokyo (JP); Toshio YAMAZAKI, Tokyo (JP); Katsuyuki NAKAMURA, Tokyo (JP)

(73) Assignee: MITAKA KOHKI CO., LTD., Tokyo (JP)

(21) Appl. No.: 14/083,740

(22) Filed: Nov. 19, 2013

(30) Foreign Application Priority Data
Nov. 21, 2012 (JP) 2012-255127

(51) Int. Cl. G02B 21/36; G02B 27/22

(52) U.S. Cl. CPC G02B 21/368; G02B 27/2228
USPC 359/477

(57) ABSTRACT

An electronic image display apparatus has a casing. The casing incorporates objective optical systems and imaging optical systems to form primary images that are observed through eyepiece optical systems. With this configuration, the display apparatus is able to provide images that are observable naturally like images provided by a surgical microscope, thereby improving an observation performance and causing no fatigue on an observer even after a long time of observation.

### BACKGROUND OF THE INVENTION

1. Field of the Invention

The present invention relates to an electronic image display apparatus.

2. Description of Related Art

The electronic image display apparatus is used with, for example, a surgical microscope. The surgical microscope provides optical images of a target part, and from the optical images, the electronic image display apparatus takes a pair of left and right electronic images having binocular parallax to realize a stereoscopic view and displays the electronic images on a pair of left and right display panels installed in the display apparatus so that an observer may watch a stereoscopic image of the target part through a pair of left and right eyepiece lenses of the display apparatus.

The electronic image display apparatus usually includes a casing, the pair of left and right display panels arranged at a first end of the casing to display electronic images, and a pair of left and right eyepiece units including the eyepiece lenses arranged at a second end of the casing to view the displayed images.

The surgical microscope provided with the electronic image display apparatus is manipulated by a main doctor to optically and three-dimensionally observe a target part, i.e., an affected part of a patient through eyepiece units of the surgical microscope. At this time, the electronic image display apparatus is manipulated by an assistant to three-dimensionally observe the same vision as that observed by the main doctor by watching electronic images provided by the display apparatus. A related art is disclosed in, for example, Japanese Unexamined Patent Application Publication No. 2004-320722.

### SUMMARY OF THE INVENTION

According to the related art, images displayed on the display panels of the electronic image display apparatus are viewed only through the eyepiece lenses, and therefore, a person who observes the target part through the display apparatus may feel some unnaturalness compared with observing the same through the surgical microscope that shows the target part through objective and imaging lenses in addition to the eyepiece lenses.

The electronic image display apparatus employing only the eyepiece lenses spreads light in every direction, and therefore, electronic images provided by the display apparatus are visible wherever the eyes of an observer are placed. On the other hand, the surgical microscope first forms primary images through the objective and imaging lenses and makes an observer see the primary images through the eyepiece lenses. In this case, light travels in a specific direction, and therefore, no image is observable unless the eyes of the observer are placed at eye points outside the eyepiece lenses where the light crosses. Medical persons are accustomed to use the surgical microscope that requires an observer to put his or her eyes on the eye points of the eyepiece lenses and this is the reason why they feel unnaturalness when they observe images through the electronic image display apparatus having no eye points.

In consideration of such a problem of the related art, the present invention provides an electronic image display apparatus capable of displaying images like the surgical microscope so that the images are observed without an unnatural feeling.

According to an aspect of the present invention, the electronic image display apparatus has a casing, a pair of left and right display panels arranged inside the casing, and a pair of left and right eyepiece units including eyepiece optical systems arranged at an end of the casing. The display apparatus includes a pair of left and right objective optical systems that are arranged inside the casing to receive light from the display panels and a pair of left and right imaging optical systems that are arranged inside the casing to form primary images from the light transmitted through the objective optical systems, respectively, so that the primary images are enlarged and observed through the eyepiece optical systems.

### BRIEF DESCRIPTION OF THE DRAWINGS

FIG. 1 is a perspective view illustrating a surgical microscope and an electronic image display apparatus according to a first embodiment of the present invention;

FIGS. 2 and 3 are views illustrating an internal structure of the surgical microscope;

FIG. 4 is a view explaining optical systems of the surgical microscope;

FIG. 5 is a view illustrating a relationship between a camera installed on the surgical microscope and display panels installed in the electronic image display apparatus;

FIGS. 6 and 7 are views illustrating an internal structure of the electronic image display apparatus;

FIG. 8 is a perspective view illustrating a surgical microscope used with an electronic image display apparatus according to a second embodiment of the present invention;

FIG. 9 is a perspective view illustrating an internal structure of the surgical microscope of FIG. 8; and

FIG. 10 is a sectional view illustrating an internal structure of a camera installed on the surgical microscope of FIG. 8.

### DESCRIPTION OF PREFERRED EMBODIMENTS

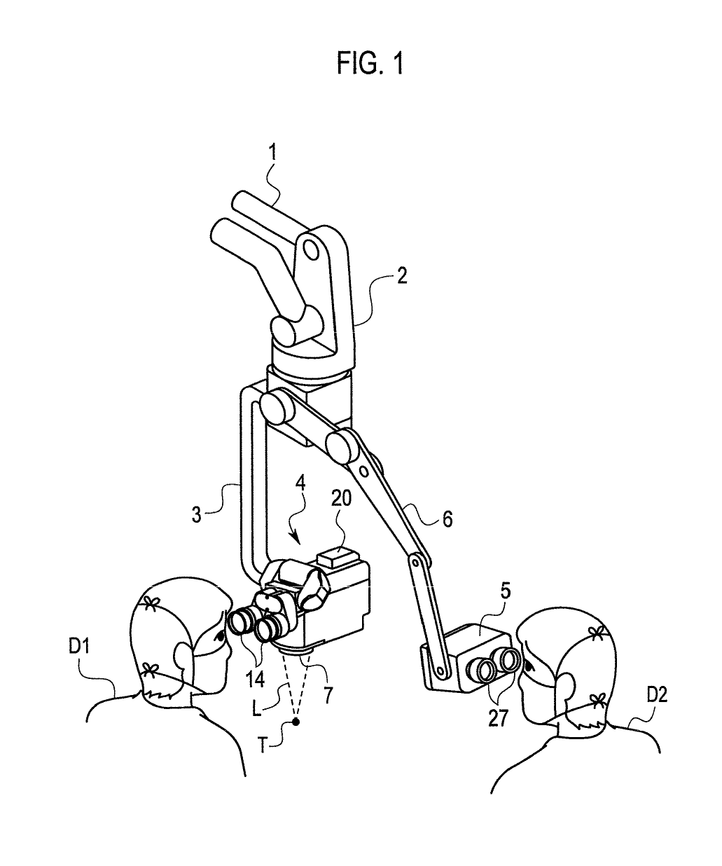

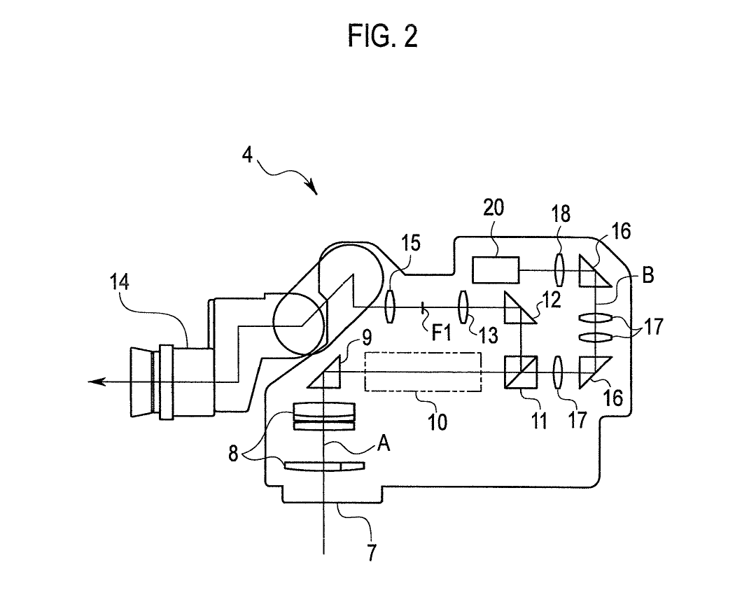

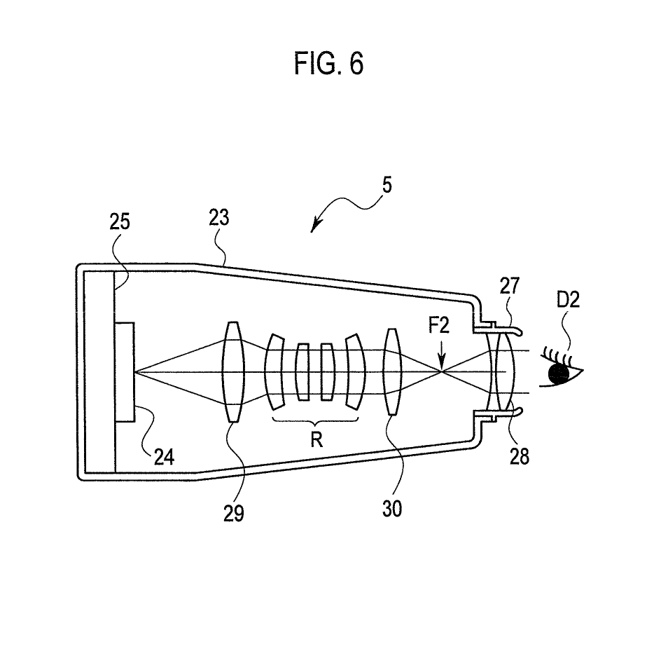

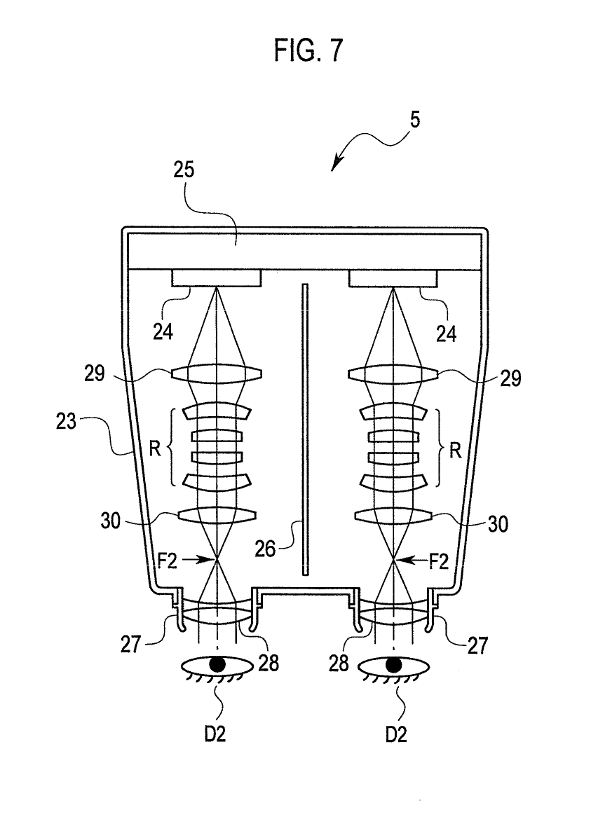

An electronic image display apparatus according to the first embodiment of the present invention will be explained with reference to FIGS. 1 to 7.

In FIG. 1, a support arm 1 horizontally extends from a medical stand (not illustrated) arranged in an operating room. A front end 2 of the support arm 1 is attached to a suspension arm 3 having a U-shape. A lower end of the suspension arm 3 supports a surgical microscope 4 manipulated by a doctor D1.

On the right side of the surgical microscope 4, the electronic image display apparatus 5 according to the first embodiment of the present invention is supported with a support arm 6 that extends from the front end 2 of the support arm 1. The display apparatus 5 is manipulated by an assistant D2 who is on the right side of the doctor D1.

The surgical microscope 4 allows a stereoscopic observation. For this, left and right main optical paths A are defined microscope the surgical microscope 4. At a lower part of the surgical microscope 4, a light inlet 7 is formed. Above the light inlet 7, an objective optical system 8 having lens groups is vertically arranged. Above the objective optical system 8, prisms 9 are arranged. Arranged behind the prisms 9 are horizontal variable-power optical systems 10 having lens groups.

Behind the variable-power optical systems 10 as zoom lens systems, beam splitters 11 and prisms 12 are vertically arranged to upwardly and then forwardly bend the optical paths A. The optical paths A pass through imaging optical systems 13 to form primary images F1 and reach eyepiece units 14. The eyepiece units 14 have eyepiece optical systems 15, respectively, through which the doctor D1 optically three-dimensionally observes the primary images F1.

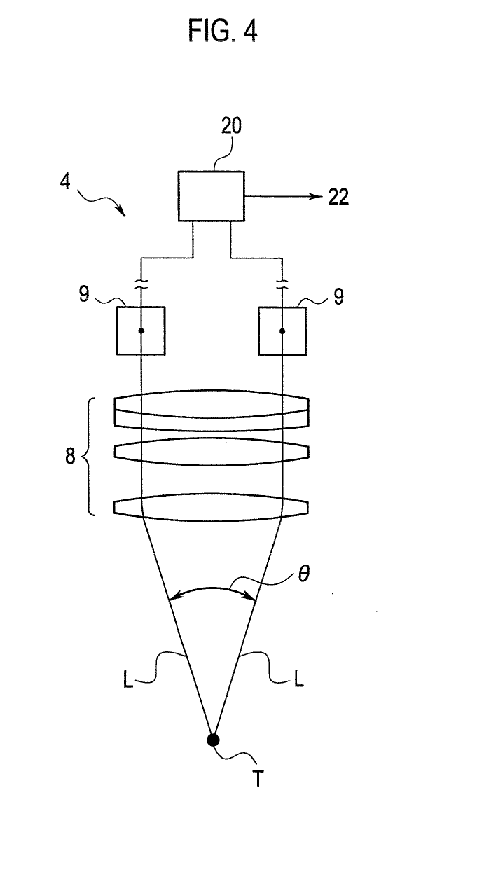

As illustrated in FIG. 4, light L from an affected part, i.e., a target part T of a patient is guided at a convergence angle theta (θ) into the objective optical system 8. The light L is divided by the objective optical system 8 into the two optical paths A that are guided through the prisms 9 and the like to the pair of left and right eyepiece units 14 for the left and right eyes of the doctor D1. Due to the convergence angle theta (θ), the primary images F1 from the eyepiece units 14 involve binocular parallax, and therefore, are stereoscopically observable.

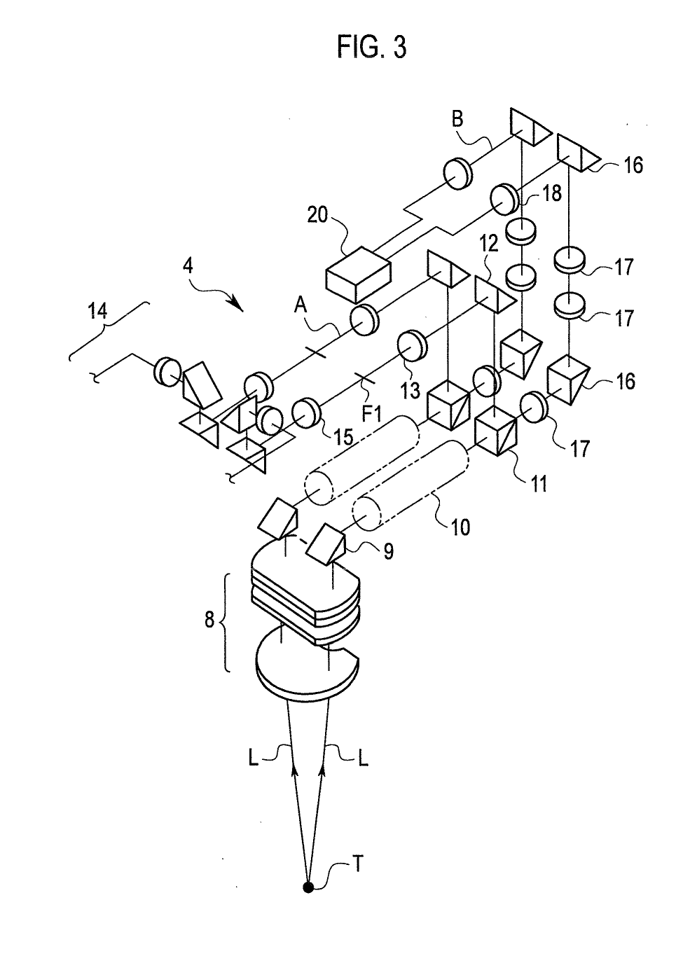

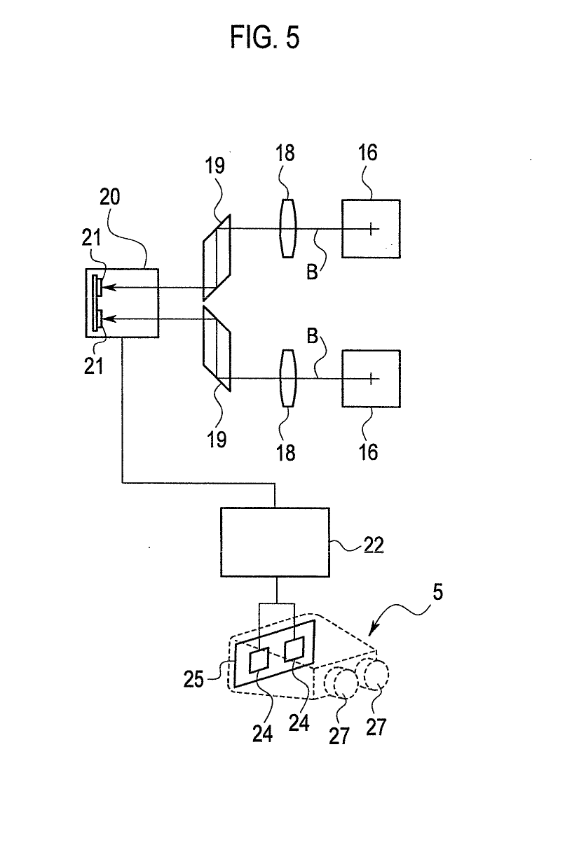

The main optical paths A are split by the beam splitters 11 into sub-optical paths B, respectively. As illustrated in FIGS. 3 and 5, the sub-optical paths B pass through prisms 16, lenses 17, relay lenses 18, and parallelogram prisms 19 to a camera 20 installed on the surgical microscope 4.

The camera 20 incorporates a pair of left and right CCD image sensors (hereinafter referred to as “CCDs”) 21 that are two-dimensional photographing elements. The CCDs 21 take a pair of electronic images having binocular parallax. The electronic images taken by the CCDs 21 of the camera 20 are outputted through a controller 22 to the electronic image display apparatus 5.

The electronic image display apparatus 5 has a casing 23 that incorporates a pair of left and right display panels 24. The display panels 24 are organic electroluminescence panels in this embodiment and are assembled to a substrate 25 that receives electronic image signals from the controller 22. The casing 23 also incorporates a partition 26 that separates an inner space of the casing 23 into two. Opposite to the display panels 24, the casing 23 has a pair of left and right eyepiece units 27 that each include an eyepiece optical system 28.

In addition to the eyepiece units 27, the casing 23 incorporates objective optical systems 29, imaging optical systems 30, and relay optical systems R arranged between the optical systems 29 and 30. Each objective optical system 29 receives light from the corresponding display panel 24 and each imaging optical system 30 forms a primary image F2 from light transmitted through the corresponding objective optical system 29. Each primary image F2 is enlarged through the eyepiece optical system 28 and is observed by the eye of the assistant D2. When watching the primary image F2, the eve of the assistant D2 is placed on an eye point where light from the eyepiece optical system 28 crosses. The pair of left and right display panels 24 display electronic images having binocular parallax, and therefore, the assistant D2 is able to stereoscopically observe the images through the eyepiece units 27.

According to the embodiment, the electronic image display apparatus 5 used by the assistant D2 is separately supported from the surgical microscope 4 used by the doctor D1. Accordingly, even if the doctor D1 moves the surgical microscope 4, the electronic image display apparatus 5 causes no movement. Namely, the doctor D1 and assistant D2 are allowed to freely move the surgical microscope 4 and electronic image display apparatus 5 without interfering with each other. This improves operability of the devices 4 and 5 for the two persons.

The electronic image display apparatus 5 incorporates the objective optical systems 29 and imaging optical systems 30 in the casing 23. The primary images F2 formed through these optical systems 29 and 30 are observed through the eyepiece optical systems 28. Namely, the display apparatus 5 allows an observer to observe the primary images F2 like the surgical microscope 4 without an unnatural feeling. This improves an observation performance of the display apparatus 5 and causes no fatigue on an observer even after a long time of observation.

Accommodating the objective optical systems 29 and imaging optical systems 30 in the casing 23 of the electronic image display apparatus 5 improves an optical performance of the display apparatus 5. Depending on the resolution and response speed of the display panels 24, the display apparatus 5 is able to provide finer electronic images. The display panels 24 made of organic electroluminescence panels are superior to liquid crystal panels in response speed and contrast and such superior characteristics can fully be utilized when images on the display panels 24 are observed through the objective optical systems 29, imaging optical systems 30, and eyepiece units 27.

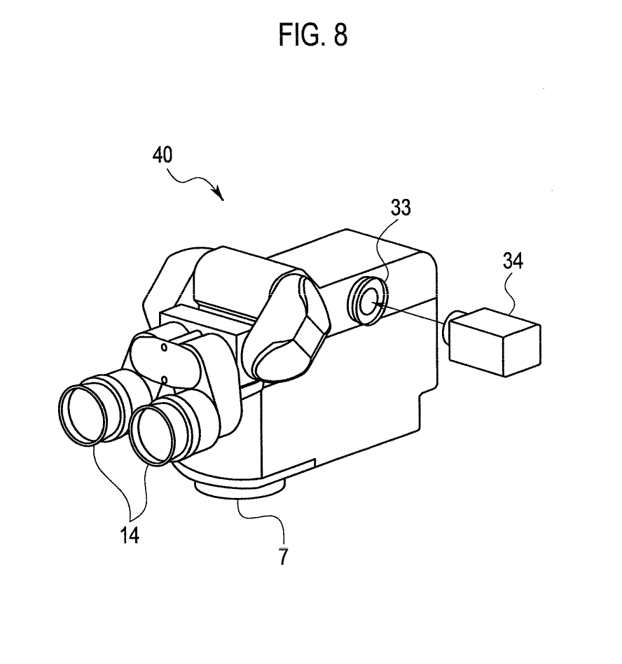

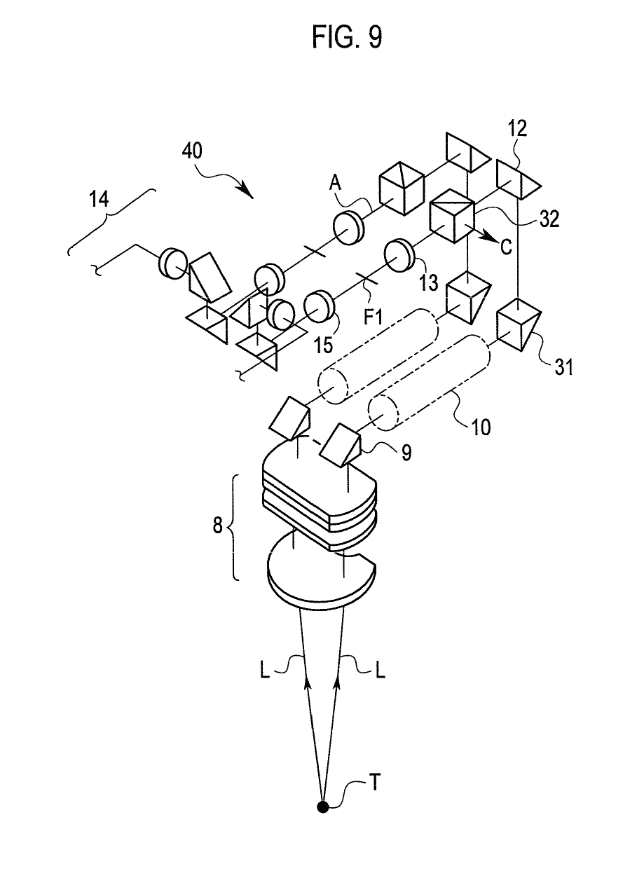

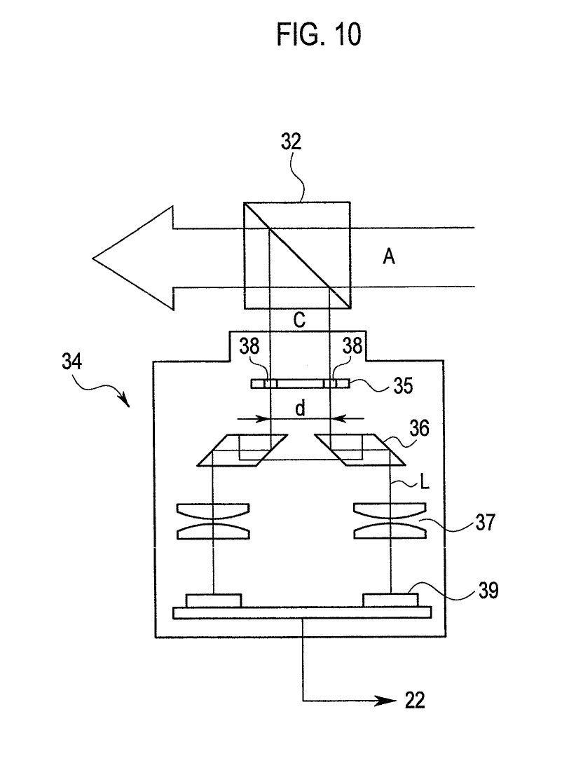

An electronic image display apparatus according to the second embodiment of the present invention will be explained with reference to FIGS. 8 to 10. The second embodiment is similar to the first embodiment, and therefore, like elements are represented with like reference marks in FIGS. 8 to 10 to omit overlapping explanations.

The electronic image display apparatus according to the second embodiment is used with a surgical microscope 40. In the surgical microscope 40, main optical paths A are totally upwardly reflected by prisms 31 and are bent toward eyepiece units 14. Unlike the first embodiment, the second embodiment creates no sub-optical paths from the main optical paths A.

Instead, the second embodiment arranges beam splitters 32 in the main optical paths A in front of imaging optical systems 13. Each beam splitter 32 branches the corresponding main optical path A at a right angle into a sub-optical path C. The sub-optical path C goes outside from a light outlet 33 arranged on the right (left) side of the surgical microscope 40. According to the second embodiment, only the light outlet 33 on the right side is used and the light outlet 33 on the left side is closed. The light outlet 33 on the right side is connected to a camera 34.

The camera 34 incorporates a slit plate 35, a pair of left and right parallelogram prisms 36, and a pair of left and right relay lenses 37, to form a light dividing unit.

The slit plate 35 has a pair of left and right holes 38 to divide the sub-optical path C branched by the beam splitter 32 of the surgical microscope 40 into two parallel beams L that are guided to the CCDs 39. The CCDs 39 form electronic images from the beams L and the electronic images are outputted through a controller to the electronic image display apparatus 5.

In this way, the second embodiment branches one of the main optical paths A of the surgical microscope 40 into the sub-optical path C and divides the sub-optical path C into the two parallel beams L. Accordingly, the parallel beams L involve a slight parallax d. Due to this parallax d, the electronic image display apparatus 5 provides pseudo three-dimensional images instead of simple two-dimensional images.

Although the first and second embodiments support the electronic image display apparatus 5 on the right side of the surgical microscope 4 (40), the electronic image display apparatus 5 may be placed at any position with respect to the surgical microscope 4 (40). For example, the electronic image display apparatus 5 may be arranged on the left side of the surgical microscope 4 (40), or at a position opposite to the doctor D1.

The electronic image display apparatus 5 is usable not only for the assistant D2 but also for nurses or interns for their study by installing it in a room other than the operating room.

The display panels 24 of the electronic image display apparatus 5 are not limited to the organic electroluminescence display panels. They may be transmissive liquid crystal display panels, reflective liquid crystal display panels, or any other display panels.

In this way, the electronic image display apparatus according to the present invention incorporates the objective optical systems and imaging optical systems inside the casing of the display apparatus. These optical systems form primary images that are observable through the eyepiece optical systems like images provided by an ordinary surgical microscope, and therefore, an observer of the display apparatus can watch the images without an unnatural feeling. With such improved observation performance, the electronic image display apparatus of the present invention causes no fatigue on the observer even after a long time of observation. The objective optical systems and imaging optical systems arranged inside the casing of the electronic image display apparatus improve an optical effectiveness to provide finer electronic images if the resolution and response speed of the display panels are designed accordingly.

When electronic images displayed on the display panels of the electronic image display apparatus of the present invention are based on two optical paths defined in a surgical microscope, the electronic images involve binocular parallax and are stereoscopically observable. When the electronic images are based on a beam branched from one of the two optical paths defined in the surgical microscope, the electronic images involve parallax and are observable as pseudo three-dimensional images.

This application claims benefit of priority under 35 USC §119 to Japanese Patent Application No. 2012-255127, filed on Nov. 21, 2012, the entire contents of which are incorporated by reference herein. Although the invention has been described above by reference to certain embodiments of the invention, the invention is not limited to the embodiments described above. Modifications and variations of the embodiments described above will occur to those skilled in the art, in light of the teachings. The scope of the invention is defined with reference to the following claims.

What is claimed is:

1. An electronic image display apparatus having a casing, a pair of left and right display panels arranged inside the casing, and a pair of left and right eyepiece units including eyepiece optical systems arranged at an end of the casing, the apparatus comprising:
a pair of left and right objective optical systems arranged inside the casing configured to receive light from the display panels; and
a pair of left and right imaging optical systems arranged inside the casing configured to form primary images from the light transmitted through the objective optical systems, respectively, so that the primary images are enlarged and observed through the eyepiece optical systems.

2. The electronic image display apparatus of claim 1, wherein the display panels display electronic images respectively, the electronic images being formed from beams transmitted through two optical paths of a surgical microscope respectively and having binocular parallax.

3. The electronic image display apparatus of claim 1, wherein the display panels display electronic images respectively, the electronic images being formed from beams branched from one of two optical paths of a surgical microscope and having parallax.

4. The electronic image display apparatus of claim 1, wherein the display panels are of an organic electroluminescence type.
